(19) United States
(12) Patent Application Publication
(10) Pub. No.: US 2009/0060510 A1
(43) Pub. Date: Mar. 5, 2009

(54) Optical Network Terminal Apparatus

(76) Inventor: Richard J. Baca, Plano, TX (US)

Correspondence Address: DAVIS & ASSOCIATES, P.O. BOX 1093, DRIPPING SPRINGS, TX, 78620, US

(21) Appl. No.: 11/845,776

(22) Filed: Aug. 27, 2007

(51) Int. Cl. H04J 14/00

(52) U.S. Cl. 398/72

(57) ABSTRACT

A distributed optical network terminal apparatus includes an n-plexer selecting a plurality of downstream channels of a received wavelength division multiplexed (WDM) optical signal. A wavelength translator block translates each selected channel of the WDM optical signal to an associated downstream translated optical signal having a wavelength distinct from that of the associated channel.

### TECHNICAL FIELD

This invention relates to the field of communications. In particular, this invention is drawn to methods and apparatus for optical communications.

### BACKGROUND

Optical communications networks are used to transport large amounts of information attributable to voice, data, and video communications. These communications are in the form of optical signals carried by fiber optic cables.

Optical fiber might be used for long-haul transport between central office hubs of telecommunication providers. The optical fiber infrastructure has begun to encroach on traditional wireline infrastructure as optical fiber is extended closer to customer premises.

For example, fiber has been extended from the central office “to the curb”, i.e., a service node near one or more customer buildings as a result of growing demand for increased bandwidth at a local level. The connection between individual buildings and the service node is completed with traditional wireline medium such as copper wires. An optical network unit (ONU) provided the optical-to-electrical and electrical-to-optical conversion required for interfacing the fiber portion of the network with the copper wire portion. The ONU communicates with an optical line terminal (OLT) at the central office.

Decreasing costs of fiber, increasing demand for bandwidth, and lower infrastructure costs have encouraged extension of the optical fiber all the way to the customer premises. An optical network terminal (ONT) terminates the fiber optic network at or near the customer premises and provides the interface between the optical network and any electrical media.

Flexibility in locating the ONT is desired in order to support the installation requirements at the customer premises. Positioning of the ONT is often constrained by the physical limitations of the optical fiber feeding the ONT. Glass optical fibers such as single mode fiber experience high losses in the event of bending. Thus the ONT typically cannot be positioned near existing distribution points within customer premises if the optical fiber must take a route through the premises that requires excessive bending.

### SUMMARY

In one embodiment, a method includes translating received channels from a wavelength-division multiplexed (WDM) optical signal carried by an optical fiber of a first type into a plurality of translated optical signals having optical wavelengths distinct from those of the received channels. The translated optical signals are communicated on at least one optical fiber of a second type.

In one embodiment, a method includes translating at least one non-wavelength division multiplexed (non-WDM) optical signal carried by an optical fiber of a first type into a translated optical signal having an optical wavelength distinct from that of the non-WDM optical signal. The translated optical signal is communicated as one channel of a WDM optical signal on an optical fiber of a second type.

One embodiment of a distributed optical network terminal apparatus includes an n-plexer selecting a plurality of downstream channels of a received wavelength division multiplexed (WDM) optical signal. A wavelength translator block translates each selected channel of the WDM optical signal to an associated downstream translated optical signal having a wavelength distinct from that of the associated channel.

### BRIEF DESCRIPTION OF THE DRAWINGS

Embodiments of the present invention are illustrated by way of example and not limitation in the figures of the accompanying drawings, in which like references indicate similar elements and in which:

FIG. 1 illustrates a prior art optical network terminal.

FIG. 2 illustrates one embodiment of a distributed optical network terminal.

FIG. 3 illustrates one embodiment of wavelength translation circuitry associated with the primary optical network terminal.

FIG. 4 illustrates one embodiment of the optical interface for the secondary optical network terminal.

FIG. 5 illustrates one embodiment of a method of translating downstream optical signals from a WDM optical signal for communication to the secondary ONT.

FIG. 6 illustrates one embodiment of a method of translating upstream optical signals from the secondary ONT to channels of a WDM optical signal.

FIG. 7 illustrates various embodiments of a single service secondary ONT.

### DETAILED DESCRIPTION

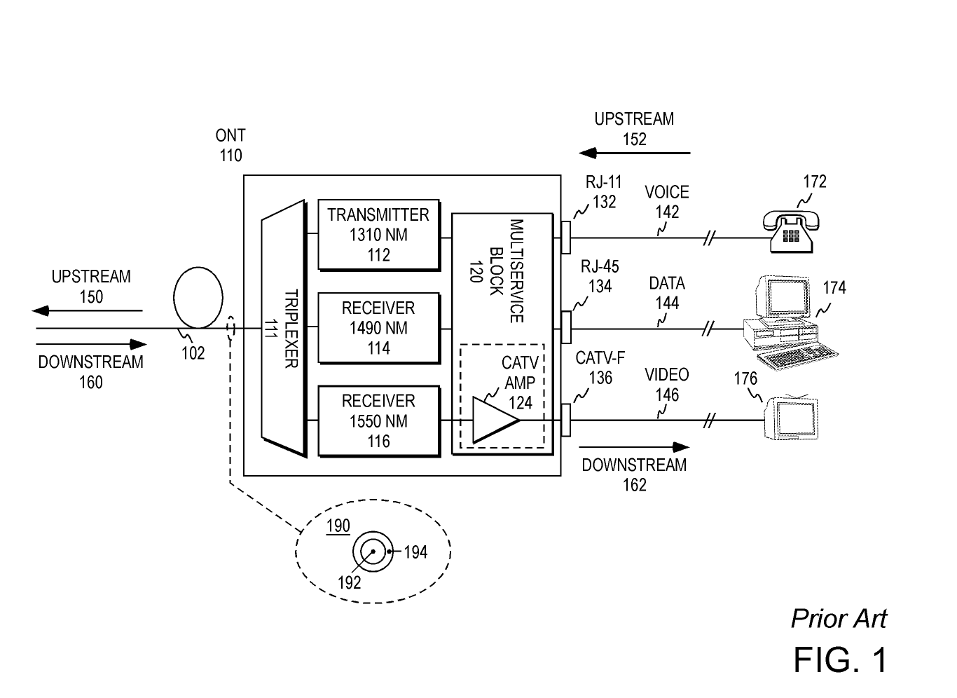

FIG. 1 illustrates one embodiment of a prior art optical network terminal (ONT 110). The illustrated configuration is a “fiber to the home” optical network. In one embodiment the optical network terminal is a “triple play” ONT transporting information attributable to voice, data, and video communications.

Communications (upstream 150 and downstream 160) between the ONT and a central office headend are optical. The optical communications are carried by an optical fiber 102. Communications (upstream 152, downstream 162) between the ONT and subscriber equipment are electrical. The electrical signals may be carried by various electrical cabling including telephone wire (voice 142), coaxial cable (video 146), or other cabling (data 144). The ONT provides optical-to-electrical and electrical-to-optical conversion as well as other functionality required for interfacing the fiber portion of the network with the electrical portion of the network.

As illustrated by callout 190, optical fiber 102 include a core 192 and a cladding 194. The core and cladding have different refractive indices. An optical fiber 102 coupling the ONT to a distant upstream node such as a central office typically has a glass core and may be referred to as a glass optical fiber (GOF) based upon material of construction. In conjunction with wavelength division multiplexing, GOF can carry very large amounts of information between the customer premises and the central office. Wavelength division multiplexing (WDM) is a technique that permits communication of multiple channels of information using the same communication media by assigning different channels of information to different optical wavelengths.

In the illustrated embodiment, subscriber equipment such as telephones 172, computers 174, and televisions 176 are coupled to ONT 110 using different types of media. The type of media is dictated at least in part by electrical specifications associated with the related service.

For example, video 146 is typically distributed using coaxial cable due to the high frequency analog signals involved. Data 144 is often communicated on multiconductor data cables such as Ethernet cables for carrying digital signals. Plain old telephone system (POTS) equipment such as a telephone 172 typically uses copper wire pairs. Generally services provided to POTS equipment are referred to as voice 142. The term “voice” includes voiceband communications.

ONT 110 includes the appropriate physical connector to interface with the physical media for each service. For example, ONT 110 includes an RJ-11 connector 132 for voice services, an RJ-45 connector 134 for data services, and a coaxial “F” connector 136 for video services. ONT 110 provides the interface between the electrical and optical media. The customer premises may thus be wired with multiple media including coaxial cable, POTS wiring, and the appropriate data cabling to support the different services throughout the premises.

Upstream and downstream communications between the ONT and the central office share the same optical fiber media. Different services, however, may be associated with different wavelengths carried by the optical fiber. In the illustrated embodiment, a first optical wavelength (1310 nm) is utilized for upstream voice and data. A second optical wavelength (1490 nm) is utilized for downstream voice and data. A third optical wavelength (1550 nm) is utilized for downstream video. Channels and optical wavelengths may thus be provisioned based upon the content and direction of the communications among other factors. The optical signal carried by optical fiber 102 may thus be wavelength division multiplexed (WDM).

Triplexer 111 serves to aggregate optical signals generated by upstream transmitters 112 for upstream communications by optical fiber 102. Triplexer 111 also optically demultiplexes the incoming WDM optical signal to extract selected downstream channels for their associated receivers 114, 116.

A multiservice block 120 provides the appropriate functionality for interfacing the ONT with the downstream subscriber equipment and the upstream optical network. For example, multiservice block 120 may include a media access control (MAC) to permit unique identification of the ONT by the upstream optical network. A downstream-only video signal may simply require amplification as illustrated by CATV 124 amplifier.

Data and voice share the same upstream and downstream channels on the optical fiber 102. Voice and data, for example, may be time division multiplexed on the same upstream and downstream channels. The multiservice block demultiplexes downstream voice and data communications. The multiservice block multiplexes upstream voice and data communications from the subscriber equipment. Multiservice block also provides the appropriate electrical interface for the subscriber equipment. For example, multiservice block 120 provides subscriber line interface circuit (SLIC) functionality to support subscriber equipment coupled to the voice connector 132.

Although prior art ONTs provide for interfacing pre-existing service media with an optical network, the optical fiber 102 feeding the ONT is susceptible to bending losses. This imposes limitations on where an ONT may be positioned. Connectors may be provided to support different physical media and services on the downstream side, however the optical fiber media on the upstream side may not be so readily routed to the ONT. Moreover, due to the use of heterogeneous media, retrofitting premises with an ONT requires extending multiple types of media from a wiring closet or other location inside the premises to a demarcation point where the ONT is positioned outside of the premises.

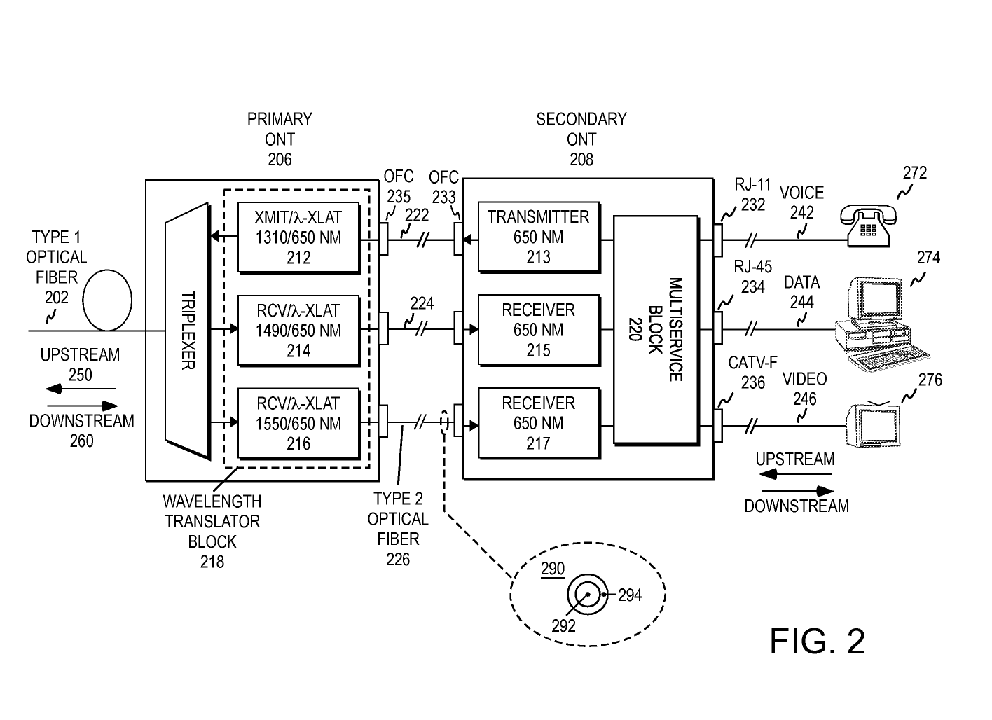

FIG. 2 illustrates one embodiment of a distributed optical network terminal. The distributed optical network terminal includes a primary ONT 206 and one or more distributed secondary ONTs 208. The primary ONT terminates a first type of optical fiber 202 carrying upstream 250 and downstream 260 communications between a central office and the primary ONT 206. In one embodiment, the first type of optical fiber 202 is a glass optical fiber (GOF). The glass optical fiber can be a single mode fiber or a multi-mode fiber.

The primary and secondary ONTs are coupled to each other with at least one optical fiber of a second type (222, 224, 226). Optical fiber 222, for example, is coupled to primary ONT at optical connector 235 and secondary ONT at optical connector 233. The second type of optical fiber communicates optical signals between the primary ONT at the demarcation point and one or more locations throughout the customer premises. In one embodiment, the second type of fiber is a plastic optical fiber.

As illustrated by callout 290, optical fibers 222, 224, 226 include a core 292 and a cladding 294. The term “plastic optical fiber” (POF) refers to the composition of the core 292. In one embodiment, the POF has an acrylic core (i.e., poly methyl methacrylate or “PMMA”). The diameter of a POF core is typically much greater than that of a GOF core. The second type of fiber may be a multi-mode fiber.

Although an intervening electrical conversion may be required, the primary ONT performs an optical wavelength translation. In the illustrate embodiment, wavelength translation occurs within the wavelength translation block 218. Optical signals on one side of the primary ONT have a different wavelength than optical signals on the other side of the primary ONT. The optical wavelength carried by one or more optical fibers 222, 224, 226 of the second type are distinct from the optical wavelength of the optical signals carried by the optical fiber of the first type 202. The optical fibers of the second type may be carrying optical signals having the same or relatively distinct optical wavelengths. In one embodiment the optical signals carried by the optical fibers of the second type have wavelengths in the visible light range. In one embodiment this range is approximately 380-750 nm.

Active optical communications can readily be verified externally to the optical fiber of the second type because of the visible light wavelengths utilized. This permits the user to engage in rudimentary diagnostics by simply viewing the optical fibers 222, 224, 226.

In one embodiment, substantially the same wavelength is utilized for each of the optical fibers of the second type 222, 224, 226. For example, a wavelength of approximately 650 nm (i.e., red) may be utilized. In another embodiment, visibly distinct wavelengths may be utilized to permit distinguished specific fibers (e.g., 222, 224, 226) or services (e.g., data, video, voice) from each other between the primary ONT and the secondary ONT.

The optical source utilized for producing the optical signals carried by the second type of optical fibers 222, 224, 226 may be one or more lasers. In one embodiment, the laser is a semiconductor laser. In another embodiment, the optical source is one or more light emitting diodes (LEDs). The optical sources may be incorporated into one or more of components 213, 214, 216.

With respect to the primary ONT 206, the terms “transmitter” and “receiver” are relative to the headend (i.e., upstream 250 direction). A transmitter component may inherently also incorporate receiver functionality. For example, transmitter/wavelength translator 212 receives an upstream optical signal at one wavelength from optical fiber 222. Transmitter 212 then transmits the optical signal on optical fiber 202 at a different wavelength. Transmitter 212 is effectively an upstream relay. (The term “wavelength translator” is abbreviated as “λ-XLAT” for illustration purposes).

A receiver component may inherently incorporate transmitter functionality. For example, receiver/wavelength translators 214, 216 receive downstream optical signals at various wavelengths (e.g., 1490 nm, 1550 nm) from optical fiber 202 and transmit them at a different wavelength on optical fibers 224 and 226, respectively.

With respect to the secondary ONT 208, the terms “transmitter” and “receiver” are likewise relative to the headend (i.e., upstream 250 direction). In addition ONT 208 performs an optical-to-electrical conversion for interfacing with the electrical media coupling the subscriber equipment to the secondary ONT. Thus transmitter 213 receives an electrical signal from multiservice block 220 and converts it to an optical signal that is transmitted along optical fiber 222 to the primary ONT. Similarly, receivers 215 and 217 receive optical signals from optical fibers 224, 226 and convert them to electrical signals that may be processed by multiservice block 220 for communication to subscriber equipment.

In some cases, data services may also be communicated via a coaxial cable attached to the coaxial connector in addition to a data cable attached to the data connector. Multiservice block 220 extracts any upstream data communications regardless of whether such communications are presented at the CATV-F connector 236, the RJ-45 connector 234, or both. Multiservice block 220 then forwards the upstream data to the central office headend using optical fiber 222. With respect to received data, the multiservice block ensures that data from optical fiber 224 is routed to the appropriate connector. Multiservice block 220 also includes a media access control (MAC) for identification of the distributed ONT to the headend of the optical network.

Multiservice block 220 provides the electrical interface with the subscriber equipment such as telephone 272, computer 274, and television 276. In the illustrated embodiment, the telephone, computer, and television are electrically coupled to multiservice block via voice 242, data 244, and video 246 lines at connectors RJ-11 232, RJ-45 234, and CATV-F 236, respectively.

In addition to handling voiceband communications, the multiservice block provides the appropriate POTS functions for subscriber equipment 272. For example, traditional subscriber line interface circuit (SLIC) functions must be provided at the secondary ONT 208 given that the communication between the central office and the ONT are otherwise optical rather than electrical. In one embodiment, the multiservice block 220 provides the BORSCHT functions (i.e., battery feed, overvoltage protection, ringing, supervision, codec, hybrid, and test).

The introduction of wavelength translation in the primary ONT permits the distribution of the optical signals to various points within the customer premises using inexpensive, robust optical fibers. In addition, the use of wavelengths in the visible light range for the distribution optical fibers enables the customer to perform at least rudimentary diagnostics from mere visual inspection.

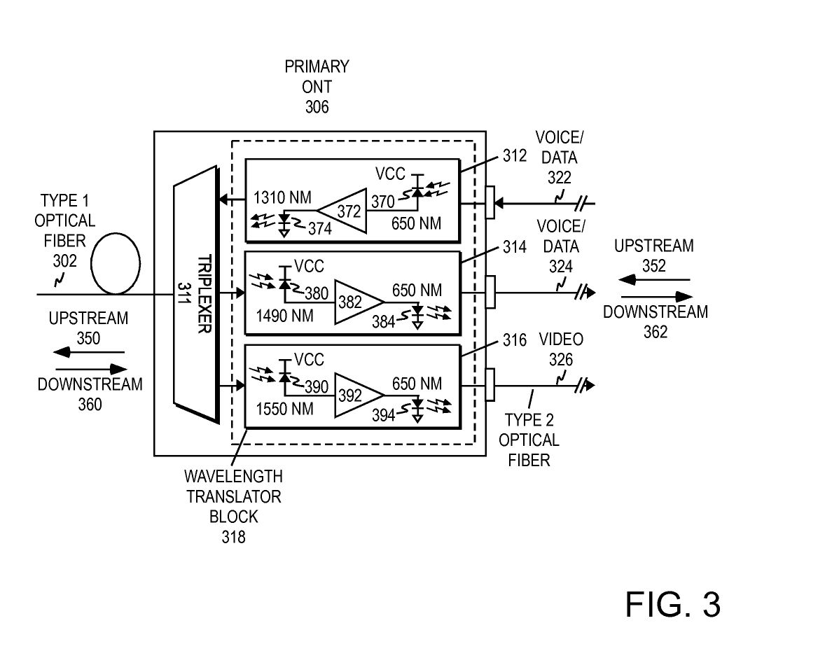

FIG. 3 illustrates one embodiment of a primary ONT including a wavelength translator block. The wavelength translator block 318 includes individual wavelength translators for each optical channel. In the illustrated embodiment, the wavelength translator block includes the wavelength translator and the receiver or transmitter. Thus there is a wavelength translator 312, 314, and 316 corresponding to the 1310 nm channel, the 1490 nm channel, and the 1550 nm channel.

Transmitter/translator 312 translates upstream optical signals at one wavelength carried by optical fiber 322 to a second wavelength carried by optical fiber 302. In the illustrated embodiment, wavelength translator 312 translates optical signals from a 650 nm wavelength to a 1390 nm wavelength for upstream voice/data.

Receiver/translator 314 translates downstream optical signals at one wavelength carried by optical fiber 302 to a second wavelength carried by optical fiber 324. In the illustrated embodiment, receiver/translator 314 translates optical signals from a 1410 nm wavelength to a 650 nm wavelength for downstream voice/data.

Receiver/translator 316 translates downstream optical signals at one wavelength carried by optical fiber 302 to a second wavelength carried by optical fiber 326. In the illustrated embodiment, receiver/translator 316 translates optical signals from a 1550 nm wavelength to a 650 nm wavelength for downstream video.

Each of the wavelength translators includes an optical detector and an optical source. The optical detector 370, 380, 390 detects an optical signal at one wavelength and provides a corresponding electrical signal. The electrical signal is provided to a driver 372, 382, 392 to drive an optical source 374, 384, 394 that generates an optical signal at a different wavelength than that of the detected optical signal.

In various embodiments, one or more of optical sources 374, 384, 394 may be a laser or a light emitting diode. In one embodiment, the optical source (374) providing upstream optical signals is a laser. In one embodiment, the optical sources (384, 394) providing downstream optical signals are light emitting diodes. In the illustrated embodiment, the downstream optical signals have the same wavelength (i.e., 650 nm). In alternative embodiments, at least one of the downstream optical signals uses a different wavelength than another downstream optical signal.

In one embodiment, the downstream optical signals carried by the second type of optical fiber utilize wavelengths in the visible light range of approximately 380-750 nm. The use of visible light permits the consumer or installer to visually determine whether optical signals are being communicated between the primary and secondary ONTs. In one embodiment, the second type of optical fiber has a substantially transparent cladding to permit the consumer to perform a visual diagnostic along the length of the second type of optical fiber.

The triplexer 311 aggregates optical signals for upstream communication and extracts optical signals for downstream communication. In the illustrated embodiment, triplexer 311 collects the 1310 nm optical signal from transmitter 312 and communicates the 1310 nm optical signal to the optical fiber 302 for upstream communication. Triplexer 311 extracts the 1490 nm and the 1550 nm downstream optical signals for receivers 314 and 316 respectively.

Although the illustrated embodiment indicates the use of a triplexer as a result of two downstream signals and one upstream signal, the number of upstream and downstream channels may vary depending upon application. Thus in general, element 311 may be an n-plexer wherein the integer value for n depends upon the sum of the number of upstream and downstream channels used. In one embodiment, channels carried by optical fiber 302 are distinguished by wavelength division multiplexing. Distribution optical fibers 222, 224, 226 may carry single channel or multi-channel optical signals. In one embodiment, channels for optical signals carried by optical fibers 222 and 224 are distinguished by time division multiplexing.

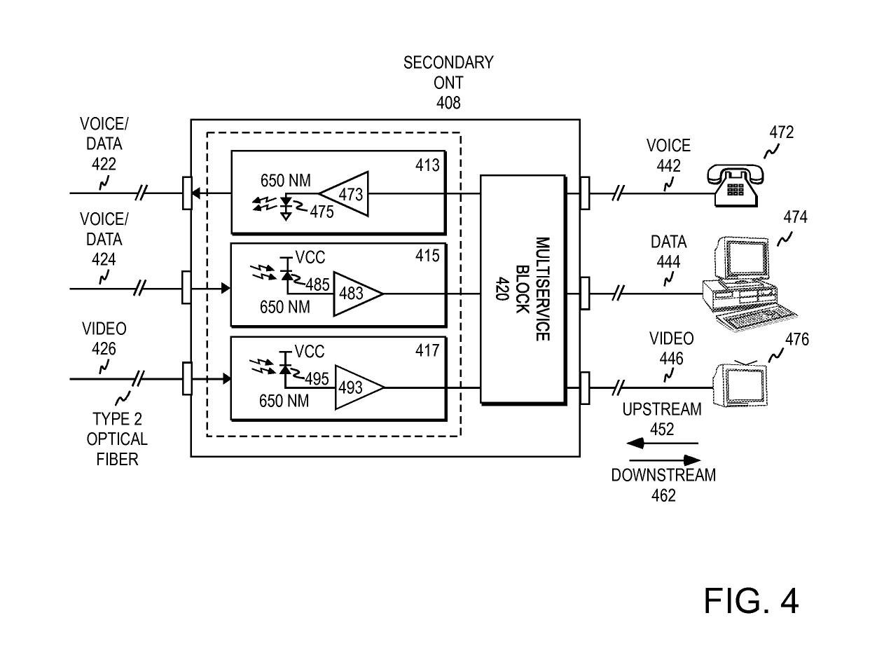

FIG. 4 illustrates one embodiment of the optical interface circuitry for the secondary ONT 408. The second type of optical fiber is carrying unidirectional optical signals (i.e., exclusively upstream 452 or downstream 462). Thus voice/data 422 is carrying time division multiplexed upstream voice and data channels. Voice/data 424 is carrying time division multiplexed downstream voice and data channels. Video 426 is carrying downstream a video channel.

Voice/data 422 is optically coupled to transmitter 413. Transmitter 413 includes an optical source 475 driven by driver 473. Control for driver 473 is provided by the multiservice block 420. In one embodiment optical source 475 is a light emitting diode.

Voice/data 424 is optically coupled to receiver 415. Receiver 415 converts the optical signal into an electrical signal via optical sensor 485 and driver 483. The electrical signal corresponding to the downstream time division multiplexed voice and data channels is then provided to the multiservice block 420.

Video 426 is optically coupled to receiver 417. Receiver 417 converts the optical signal into an electrical signal via optical sensor 495 and driver 493. The electrical signal corresponding to the downstream video signal is then provided to multiservice block 420.

Multiservice block 420 provides the electrical interface to subscriber equipment 472, 474, and 476. In the illustrated embodiment, the subscriber equipment is coupled via electrical cabling (voice 442, data 444, video 446) to multiservice block 420.

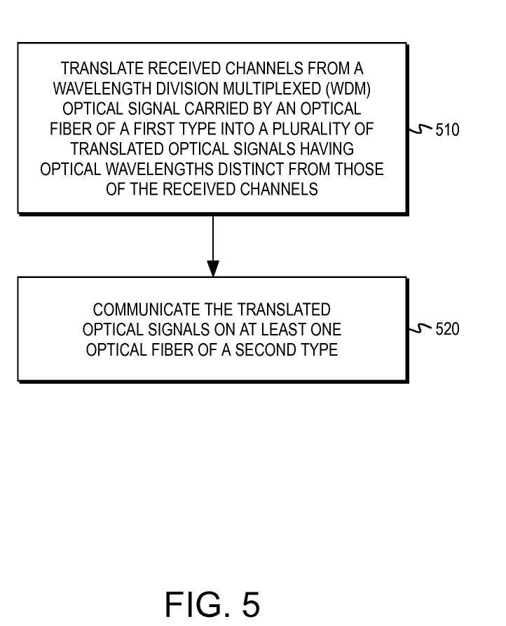

FIG. 5 illustrates one embodiment of a method of translating downstream optical signals from a WDM optical signal for communication to the secondary ONT. Channels received from a wavelength-division multiplexed optical signal carried by an optical fiber of a first type are translated into a plurality of translated optical signals having optical wavelengths distinct from those of the received channels at 510. The translated optical signals are communicated on at least one optical fiber of a second type at 520.

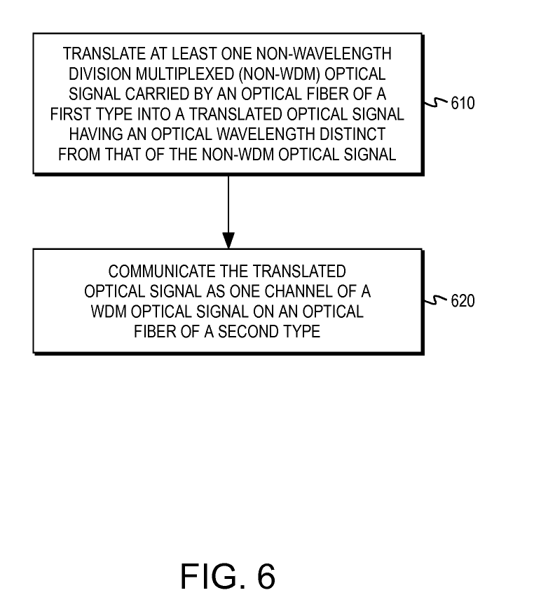

FIG. 6 illustrates one embodiment of a method of translating upstream optical signals from the secondary ONT to channels of a WDM optical signal. At least one non-wave-division-multiplexed (non-WDM) optical signal carried by an optical fiber of a first type is translated into a translated optical signal having an optical wavelength distinct from that of the non-WDM optical signal at 610. The translated optical signal is communicated as one channel of a WDM optical signal on an optical fiber of a second type at 620.

Although the secondary ONT is illustrated as supporting multiple services from a single apparatus, in various embodiments application specific secondary ONTs may be used for a specific service. For example, a video-only secondary ONT may be employed at multiple locations throughout the customer premises. Multiple receive-only secondary ONTs may tap into the second type of optical fiber. In such cases, the secondary ONT may be embodied as an external module located proximate each apparatus utilizing video services such that the second type of optical fiber rather than coaxial cable is the primary distribution media throughout the premises. In some cases, the coaxial cable may be dispensed with such that the second type of optical fiber is the only media needed to distribute video services to specific subscriber equipment.

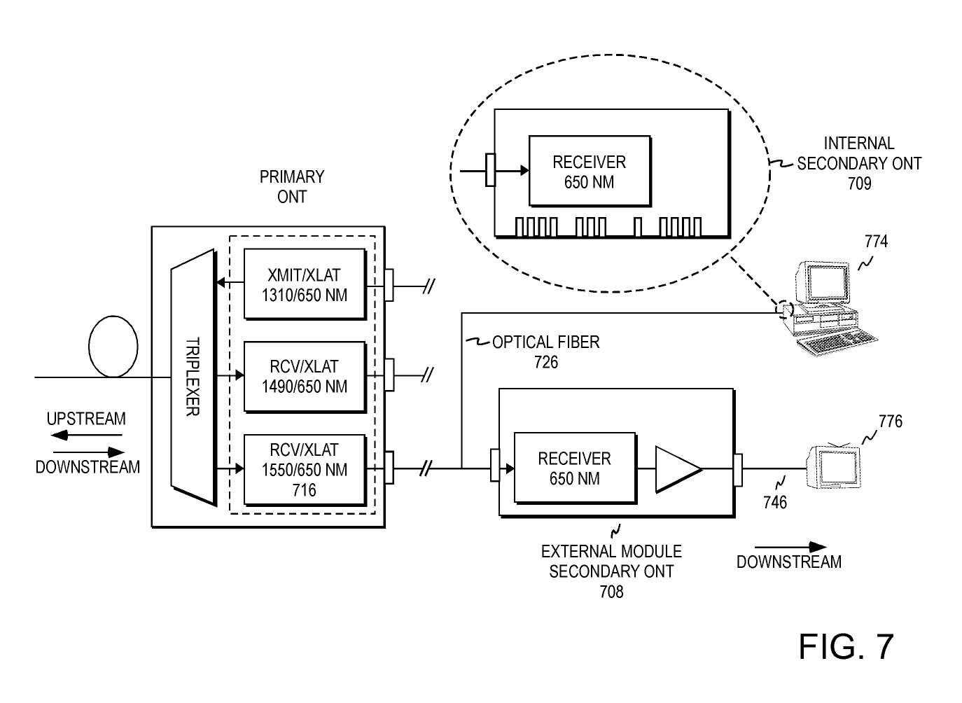

FIG. 7 illustrates one embodiment of a single service secondary ONT supporting video services as an external module 708 to subscriber equipment 776. The distribution optical fiber 726 carries the optical signal from the video receiver/translator 716 of the primary ONT throughout the customer premises to a location near the targeted subscriber equipment 776 such as a television. A relatively short length of coaxial cable 746 or other electrical media couples the external secondary ONT 708 to the targeted subscriber equipment 776.

FIG. 7 also illustrates one embodiment of a single service secondary ONT 709 incorporated into subscriber equipment such as a computer 774. In such a case, the single service secondary ONT may be implemented, for example, as a circuit board or an add-on card to permit video services “to the desktop”. In this case, the coaxial cable is dispensed with entirely such that only a single medium (optical fiber 726) is required to distribute the video services to the targeted subscriber equipment.

In the preceding detailed description, the invention is described with reference to specific exemplary embodiments thereof. Various modifications and changes may be made thereto without departing from the broader scope of the invention as set forth in the claims. The specification and drawings are, accordingly, to be regarded in an illustrative rather than a restrictive sense.

What is claimed is:

1. A method comprising:
a) translating received channels from a wavelength-division multiplexed (WDM) optical signal carried by an optical fiber of a first type into a plurality of translated optical signals having optical wavelengths distinct from those of the received channels; and
b) communicating the translated optical signals on at least one optical fiber of a second type.

2. The method of claim 1 wherein the first type of optical fiber is a glass optical fiber.

3. The method of claim 1 wherein the second type of optical fiber is a plastic optical fiber.

4. The method of claim 1 wherein each of the plurality of translated optical signals has substantially a same optical wavelength.

5. The method of claim 1 wherein the plurality of translated optical signals do not all have substantially a same optical wavelength.

6. The method of claim 1 wherein at least one of the plurality of translated optical signals has a wavelength in a visible light range of 380 nm to 750 nm.

7. The method of claim 1 wherein at least one of the plurality of translated optical signals is generated by a light emitting diode.

8. A method comprising:
a) translating at least one non-wavelength division multiplexed (non-WDM) optical signal carried by an optical fiber of a first type into a translated optical signal having an optical wavelength distinct from that of the non-WDM optical signal; and
b) communicating the translated optical signal as one channel of a WDM optical signal on an optical fiber of a second type.

9. The method of claim 8 wherein the second type of optical fiber is a glass optical fiber.

10. The method of claim 8 wherein the first type of optical fiber is a plastic optical fiber.

11. The method of claim 8 wherein the received optical signal has a wavelength in a visible light range of 380 nm to 750 nm.

12. The method of claim 8 wherein the translated optical signal is generated by a laser diode.

13. An apparatus comprising:
an n-plexer selecting a plurality of downstream channels of a received wavelength division multiplexed (WDM) optical signal; and
a wavelength translator block coupled to translate each selected channel of the WDM optical signal to an associated downstream translated optical signal having a wavelength distinct from that of the associated channel.

14. The apparatus of claim 13 wherein the wavelength of at least one of the translated optical signals is in a visible light range of approximately 380-750 nm.

15. The apparatus of claim 13 further comprising:
a plurality of receivers, each coupled to receive an associated translated optical signal; and
a multiservice block coupled to the receivers, wherein the multiservice block processes each translated optical signal to generate downstream electrical signals.

16. The apparatus of claim 15 wherein the downstream electrical signals correspond to at least one of plain old telephone service (POTS), video service, and data service.

17. The apparatus of claim 15 wherein the n-plexer is coupled to receive the WDM carried by a first type of optical fiber, wherein a second type of optical fiber communicates the translated optical signals from the wavelength translator block to the plurality of receivers.

18. The apparatus of claim 17 wherein the first type of optical fiber is a glass optical fiber.

19. The apparatus of claim 17 wherein the second type of optical fiber is a plastic optical fiber.

20. The apparatus of claim 15 further comprising:
at least one transmitter generating an upstream optical signal from an electrical upstream signal provided by the multiservice block, wherein the wavelength translator block translates each upstream optical signal to a translated upstream optical signal having a wavelength distinct from that of the upstream optical signal, wherein the n-plexer aggregates the translated upstream optical signal onto the WDM optical signal.

21. The apparatus of claim 20 wherein the upstream optical signal is a time division multiplexed signal corresponding at least one of a plain old telephone service (POTS) and a data service.

22. The apparatus of claim 20 wherein the upstream optical signal wherein the wavelength of the upstream optical signals is in a visible light range of approximately 380-750 nm.
